(19) United States
(12) Patent Application Publication
(10) Pub. No.: US 2026/0249895 A1
(43) Pub. Date: Aug. 27, 2026

(54) STORM EMERGENCY LINKABLE LIFESAVING APPARATUS (STELLA) TOWABLE RESCUE SLED

(71) Applicant: Daniel D Tuller, Porter Corners, NY (US)

(72) Inventor: Daniel D Tuller, Porter Corners, NY (US)

(21) Appl. No.: 19/548,935

(22) Filed: Feb. 24, 2026

Related U.S. Application Data
(60) Provisional application No. 63/762,502, filed on Feb. 24, 2025.

(51) Int. Cl. B62B 15/00

(52) U.S. Cl. CPC B62B 15/007; B62B 2202/42; B62B 2301/00

(57) ABSTRACT

A towable rescue sled, comprising a load bearing chassis and platform being supported by a suspension assembly and steered by a steering assembly, wherein said suspension assembly and suspension assembly and steering assembly utilize an upper control arm 8, 27 depicted in FIG. 1, and a lower control arm 14, 23, also depicted in FIG. 1. By way of this operable coupling of the steering knuckle 10 as a coupling between the steering control arm 29 and running gear for turning the sled 1 in the intended direction the independent components, now operably coupled, are effectively converted into a single curved assembly.

### BACKGROUND

### Field Of Invention

The present invention refers generally to towable rescue sleds for use in evacuating stranded travelers in winter weather conditions such as snow and ice, and more specifically to towable rescue sleds having skis alone or interchangeable skis and wheel running gear assemblies.

### Prior Art

As a former Volunteer Firefighter as well as Campus Safety Officer for SUNY, I understand the importance as well as complexities of the structuring and implementation of an actionable emergency preparedness plan. I also understand the evolution of a crisis and how the direction to a solution can sometimes be met with circumstances unplanned. In consideration of the evolution and speed of a storm like the one recently affecting the communities of Erie County and the Buffalo region, New York State was met with circumstances planned for, but also unprecedented. New systems of rescue, retrieval and safety were implemented and executed by both Erie County as well as the New York State Police however as any first responder would tell you, “You always feel like you could do more.”

Aside from the breakdowns in communication and cooperation between responding agencies, the focus issue became operational resources, not executable intentions. There were many dedicated first responders ready to prevent the loss of life but became bound to the same effects the calling public was. The storm and its effects became overwhelming for traditional transportation of those in need of emergency services, and any alternative methods would not allow the space for occupancy, or safety to a victim. It was a tragedy of terrible proportion, most important to those that experienced the loss of someone they love.

Interest:

Jan. 10, 2024—716 858 6000 Sgt J Graybar of Erie County Sheriff Office SEARCH AND RESCUE: He has extreme interest in the sled and its uses and also provided vital insight in to the requirements of it. Further Sgt states he has heard of no other suggestions or solutions in regard to a sled of this type. He is very encouraged and also provided that his agency has recently purchased equipment capable of snow terrain traverse and efficient transport of the sled.

I have contacted NYS Hazard Mitigation, NYS Emergency Management Service, NYS OGS and procurement, NYS Grants, NYS DOT as well as the New York State Police of Troop A in Buffalo and Erie County Sheriff. All are extremely interested

OFFICIAL INQUIRY, MEDIA AND SUPPORTING INFORMATION:

NYS HOMELAND AND SECURITY OFFICIAL “AFTER ACTION REVIEW”

RELEASED AUGUST 2023 FROM NY STATE.

PG. 24 Part 6 section E paragraph 4:

“Primary challenges to the search and rescue effort stemmed from the blizzard conditions and snow pack, as NYSP's vehicles were not able to navigate easily with zero visibility and significant snowfall on the road. When available, NYSP's high-axle vehicles were utilized to get through tall snowpack. However, there were a limited number of these vehicles available in NYSP inventory”

PG. 25 Part 6 section F paragraph 2:

“Emergency management, capacity goes beyond having the right equipment and resources. State and local partners must develop a shared vision of what preparation and response should be in a localized context. For example, Buffalo has narrow city streets with significant street parking, which requires certain snow removal equipment that can maneuver routes. The State understands the challenges and limitations in snow management in Buffalo. As such, the State often anticipates that Buffalo will need support in severe winter weather and therefore makes plans to support plowing and snow clearance accordingly.”

WKBW CHANNEL 7 BUFFALO NEWS

Are snowmobiles maintained by Buffalo and Erie County emergency crews?

Jan. 24, 2023
Official equipment used by Buffalo Police, Buffalo Firefighters and Buffalo's Department of Public Works.
Erie County Department of Homeland Security and Emergency Services, the county owns at least:
(1) 2003 Polaris Ranger 4×4 ATV
(4) 2013 Polaris ATVs
(1) 2021 Can-Am Defender side-by side ATV
(2) 2021 Can-Am Outlander ATVs
(4) 2019 Skidoo snowmobile
It's unclear where these pieces of equipment are stored and/or maintained.
The Buffalo Fire Department have five mechanics employed to fix issues with equipment.
Buffalo Professional Firefighters Union President, Vinny Ventresca:

“The age of the fleet and of apparatus has affected our safety and the safety of the citizens and has made it difficult to accomplish our main mission of fire suppression,”

THE WASHINGTON POST

Death toll in Buffalo blizzard rises; delayed emergency response cited_Jan. 19 2023.

The death toll to 47 Erie County officials announced delayed emergency response contributed to the deaths of an additional three people. Three residents died after they suffered cardiac events that were witnessed by friends or family and emergency responders could not get to them because of the severe weather. One person died on Christmas Eve in Cheektowaga, another died on Christmas in Amherst, about 10 minutes away, and the third died in Buffalo on December 27.

In total, seven people died because of what officials have characterized as a delayed EMS response. The majority of the dead in Erie County were found outside or in their cars, and 26 of the 46 were people of color. Another person died in Niagara County.

Storm sparked criticism of the city's emergency preparedness processes, its budget. Buffalo does not have an emergency response preparation section on website for residents information.

A former county employee, speaking on the condition of anonymity for fear of retribution, said that the city's lack of involvement and communication was not new, confirming that Buffalo consistently has not been involved in county emergency response efforts for other past storms.

Buffalo Mayor Byron Brown defended the city's handling of the storm, saying they were adequately prepared. It was a once-in-a-generation disaster, and no equipment or plan could have made much of a difference.

The council interviewing fire officials and others about the delays. filed critical resolutions to examine equipment inventory and budget, and bolster emergency responders' ability to respond.

Fillmore District council member Mitch Nowakowski pointed out that “In order to make the city safer in the future from human or natural disasters, disaster preparedness is critical.” he wrote, stating that “there were clear deficiencies in the emergency response to the December 2022 Blizzard that need to be immediately addressed.” Poloncarz said in a news conference that the city response “embarrassing.”

One of the major issues was clearing and removing snow and stranded cars from the roads, which prevented food deliveries and recovery crews from getting to residents. Critics pointed out that the city's 2022-2023 snow removal plan does not mention the word “blizzard.” Some of the equipment has also been around since 2005.

Buffalo's police and firefighters, have also been criticizing their city's emergency planning and equipment.

Last week, about 100 union members from Buffalo fire, police and public works departments attended a Common Council meeting to demand new equipment, something they say they've been requesting for years.

Ventresca has been especially outspoken about dilapidated resources and poor communication, telling lawmakers that firefighters could not get to calls for emergency medical assistance or fires, because of the clogged streets and equipment breakdowns, as well as the weather.

Since a big part of the fire department's work is EMS and its commissioner has been the technical emergency manager, Ventresca demanded that firefighters have the necessary resources for the cold season and “should be training for winter operations.”

Along with some other officials and lawmakers, he blamed some of the deaths on a “lack of planning and having to operate with outdated and broken-down rigs, equipment and firehouses.”

It is my honor to introduce you to STELLA. The Storm Emergency Linkable

Lifesaving Apparatus that will change and shape the future of austere rescue and recovery.

### BRIEF DESCRIPTION OF THE DRAWINGS

FIG. 1—depicts a rear side view of the STELLA Rescue Sled steering and suspension assembly, which are referred to as the Main Steering Cage Frame 1 when in combination.

FIG. 2 depicts a side elevation view of the left half of a STELLA Rescue Sled suspension assembly, in accordance with embodiments of the present disclosure.

FIG. 3 depicts plan view of a direction control connection arm of the STELLA Rescue Sled steering cage depicted in FIGS. 1-2, in accordance with embodiments of the present disclosure.

FIG. 4a depicts a top view of the Steering Pivot Plate 400, part of the STELLA Rescue Sled steering cage depicted in FIGS. 1-2, in accordance with embodiments of the present disclosure.

FIG. 4b depicts a side view of the Steering Pivot Plate 400, part of the STELLA Rescue Sled steering cage depicted in FIGS. 1-2, in accordance with embodiments of the present disclosure.

FIG. 4c depicts a side view of the bearing body 425 that attaches to the Steering Pivot Plate 400 depicted in FIGS. 4a and 4b via the bearing studs 422, in accordance with embodiments of the present disclosure.

FIG. 5a depicts a top view of the steering assembly of the STELLA Rescue Sled steering cage depicted in FIGS. 1-2, in accordance with embodiments of the present disclosure.

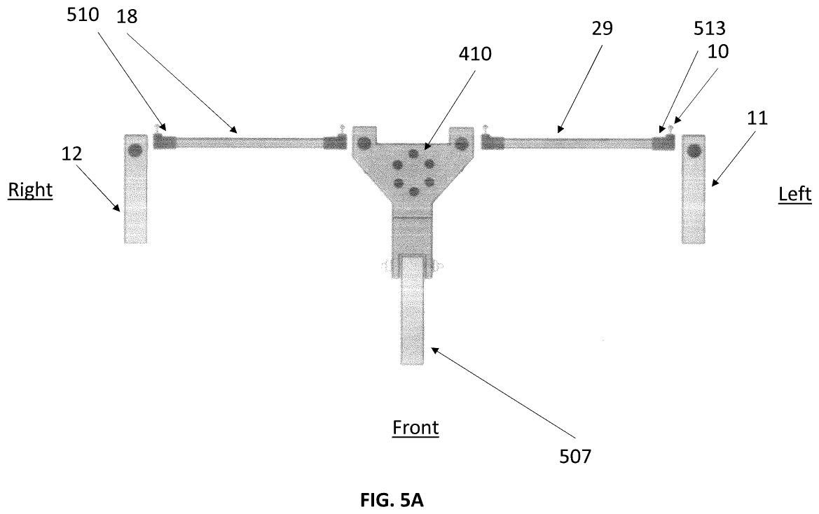

FIG. 5b depicts a top view of the steering assembly being pulled forward of the STELLA Rescue Sled steering cage depicted in FIGS. 1-2, in accordance with embodiments of the present disclosure.

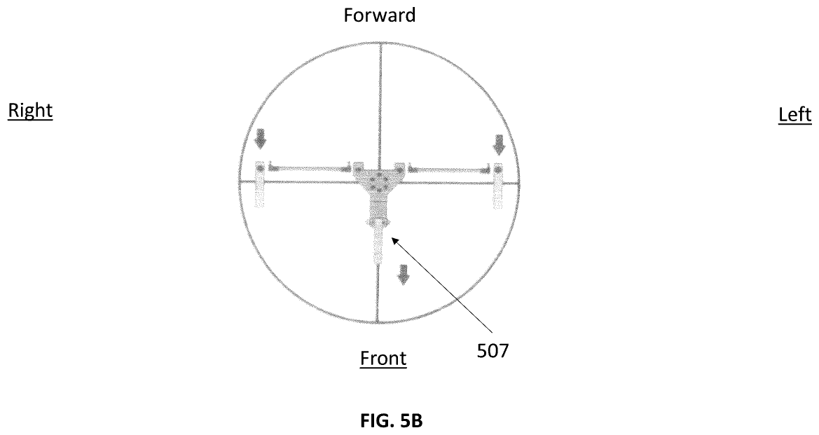

FIG. 5c depicts a top view of the steering assembly being pulled into a right turn of the STELLA Rescue Sled steering cage depicted in FIGS. 1-2, in accordance with embodiments of the present disclosure.

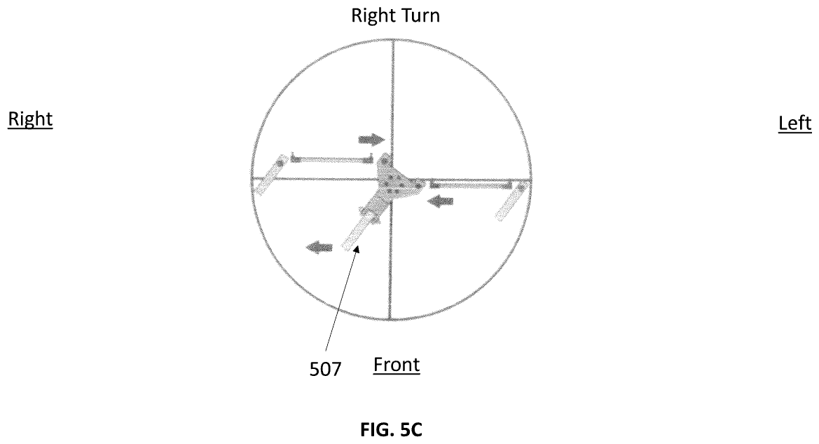

FIG. 5d depicts a top view of the steering assembly being pulled into a left turn of the STELLA Rescue Sled steering cage depicted in FIGS. 1-2, in accordance with embodiments of the present disclosure.

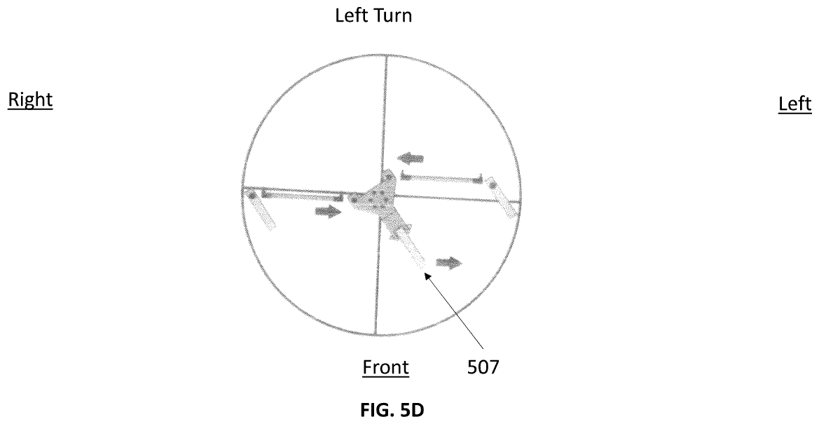

### SUMMARY OF THE INVENTION

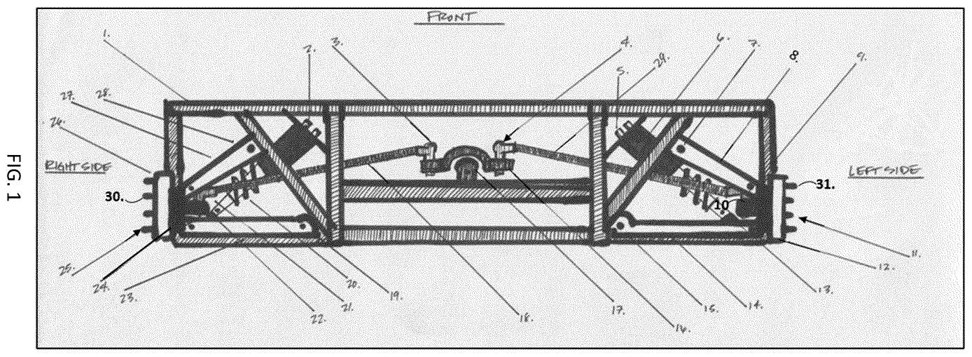

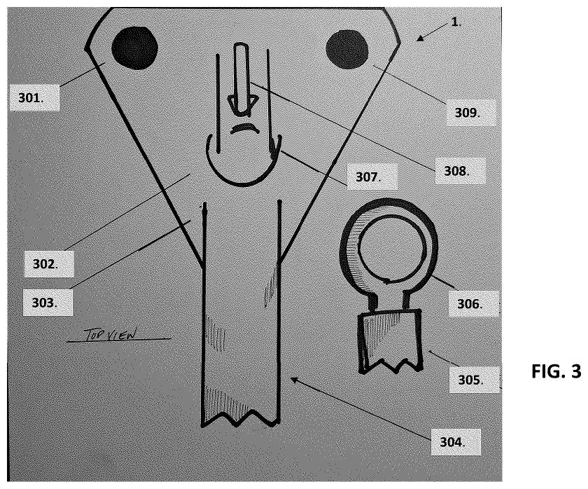

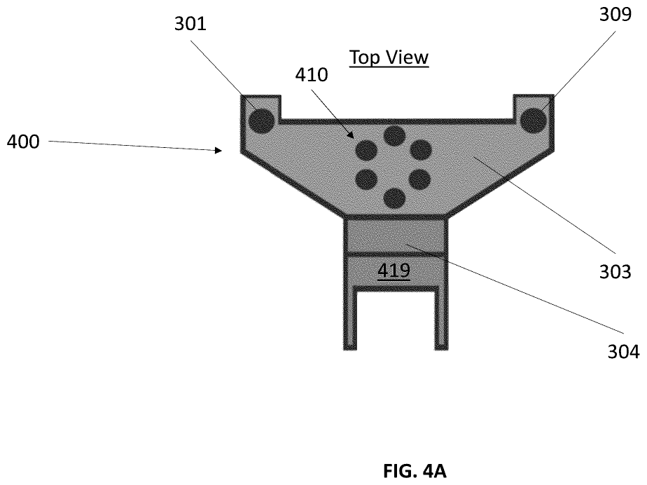

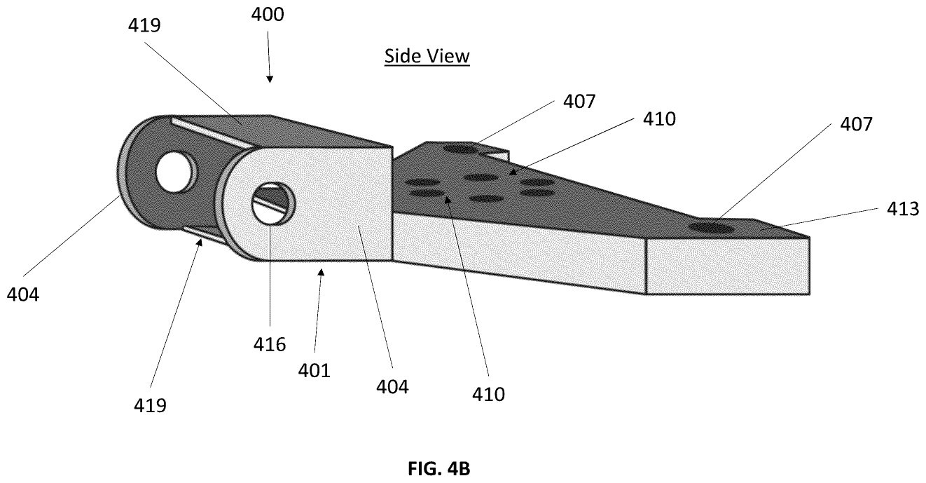

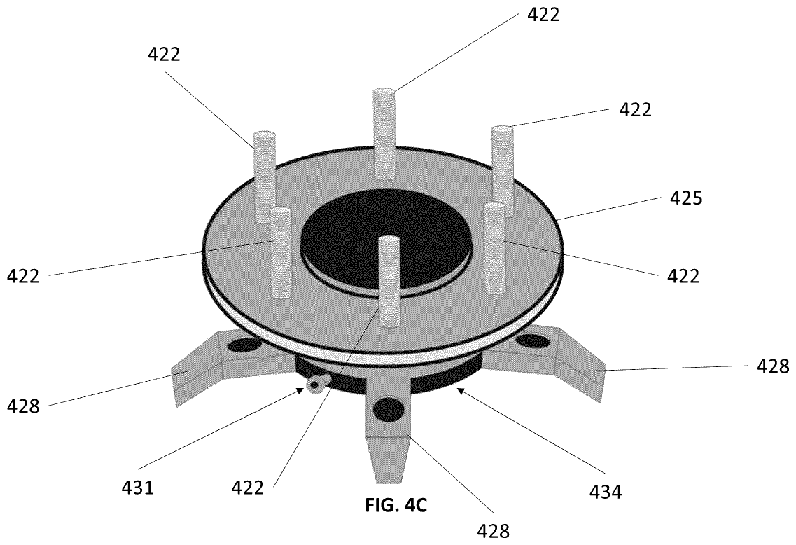

A first embodiment of the present invention provides a towable rescue sled is described, comprising a load bearing chassis and platform 1, said load bearing chassis and platform 1 being supported by a suspension assembly and steered by a steering assembly, wherein said suspension assembly and suspension assembly and a steering assembly utilize an upper control arm 8, 27 depicted in FIG. 1, and a lower control arm 14, 23, also depicted in FIG. 1, operably coupled to a steering knuckle 10, 24 and wheel hub 11, 25. These, are connected via four (4) ball joint connections 3, 4, 9, 21 to the main steering control arms 18, 29. The steering control arms 18, 29 are operably coupled to the steering knuckle 10, 24, and the steering direction control plate 303, shown in FIG. 3 and FIG. 4A. By way of this operable coupling of the steering knuckle 10 as a coupling between the steering control arm 29 and running gear for turning the sled 1 in the intended direction the independent components, now operably coupled, are effectively converted into a single curved assembly, and wherein said steering assembly comprises: a steering pivot plate 400, operably coupled to a bearing swivel base 434, comprising: bearing studs, 422; a bearing body 425; and a bearing base mount(s) 428.

### DETAILED DESCRIPTION OF THE EMBODIMENTS

### Definitions

Hereinafter, unless otherwise defined, the term “operatively coupled” means any mechanical link. More specifically, when a claim states that two elements are “coupled” (as opposed to “operatively coupled”), this means that none of the other elements defined in the claim can be interposed between those two elements.:

Unless otherwise defined, the term “TRS” means TOWABLE RESCUE SLED.

Unless otherwise defined, the term “FRP” is a composite material made of a polymer matrix reinforced with fibers. It's also known as fiber-reinforced polymer (FRP) or glass-fiber-reinforced plastic (GRP).

STELLA is a heated “towable rescue sled” capable of effective rescue and transport of up to 8 people per deployment including infant car seats. STELLA is also American Disability Act (ADA) compliant boasting the ability to accommodate and safely transport victims requiring stretchers and wheelchairs. Lastly, STELLA's technology places another crucial level of accountability in the hands of the responding agency in the form of an App monitoring the location and condition of the sled in real time, individually or fleet wide.

### 1. STELLA Features

a. Configurable interior
b. Ski-based platform suitable for snow/ice transit
c. Heated interior with basic First Aid capabilities
d. Modular (linkable) to accommodate even large-scale emergencies
e. Other critical systems, including communications and GPS

STELLA: Storm Emergency Linkable Lifesaving Apparatus

A multi-seat, towable rescue sled, described further in this report as (TRS) is designed to be an effective tool capable of life-saving implications in winter rescue operations.

The build base of the TRS prototype is on the chassis and platform of a 2024 Diamond Cargo enclosed pull-behind contractor trailer. Overall dimension 12 feet long by 6 feet wide by 6 feet 6 inches tall. Omitted from the spec to order were the travel axles and pulling tongue, not required.

The TRS is designed to be pre-deployed prior to an expected severe weather event or rapidly deployed into immediate operation upon demand. The TRS is not self-propelled but rather designed to be towed by an accompanying device exhibiting enough controlled horsepower to maintain effective control and direction throughout the operation.

Examples may include but are not limited to; Snowcat Pisten Bully vehicles, tracked or weather capable 1100 CC 4-wheel drive all-terrain vehicles. This particular towing capable vehicle although uncharacteristic of normal highway use, is considered essential equipment in severely weather-affected regions.

### 1. STELLA Interior

The Towable Rescue Sled (TRS) interior including 8 folding-style jump seats that are NY State DOT 800 compliant featuring seatbelts and automotive crash-rated design.

The TRS is entirely insulated by an R4-rated 1″ foam core capable of encapsulating and maintaining interior-generated heat, withstand extreme exterior temperature fluctuation, and remain durable and lightweight.

The TRS floor coverings consist of a 1″ plywood base subfloor directly attached to the 3″ tube chassis frame on the underside. Cavity insulated by R4 foam core board. Compartment floor covering consists of a 10 mm thick, 3M water-resistant non-slip, rubberized flooring application in a diamond tread pattern attached by flooring adhesive. It allows for easy and rapid clean-up and sanitation for after-use and redeployment readiness preparation procedures. Its durability is designed for long-term traffic with limited environmental degradation while remaining easily repaired or replaceable. The TRS walls are constructed of 1″ steel square tube beam, 16″ on center. Insulated by 1″ R4 foam core board. Primary wall covering consists of ¼″ plywood, and is entirely covered by white, fiber-reinforced panel board or FRP. This is applied by adhesive directly to the plywood walls. FRP materials are readily available making it easy to repair and replace, and also provide a clean, sanitary, and bright environment.

The TRS provides an occupant a limited viewing experience in the form of six, 12″ wide by 18″ tall sliding Recreational Vehicle style windows, three per side. When unlocked, the window can provide the occupant ventilation by sliding upward exposing an interior screen. In addition, there are two 12″ wide by 18″ tall, non-sliding windows on the rear doors.

The TRS ceiling is constructed of 1″ tube steel, bow frame, 16″ on center. It is insulated by a 1″ R4 foam core board and covered by sound and barrier foam and bright white FRP board.

The TRS walls are constructed of 1″ steel square tube beam, 16″ on center.

Insulated by 1″ R4 foam core board. Primary wall covering consists of ¼″ plywood, and is entirely covered by white, fiber-reinforced panel board or FRP. This is applied by adhesive directly to the plywood walls. FRP materials are readily available making it easy to repair and replace, and also provide a clean, sanitary, and bright environment.

The TRS provides an occupant a limited viewing experience in the form of six, 12″ wide by 18″ tall sliding Recreational Vehicle style windows, three per side. When unlocked, the window can provide the occupant ventilation by sliding upward exposing an interior screen. In addition, there are two 12″ wide by 18″ tall, non-sliding windows on the rear doors. The TRS features a locking rear slide-out style loading ramp with cross treads for user traction over icy conditions. The dual rear entry swing-away doors are wide enough to safely accommodate, load, and maneuver a single patient stretcher or wheelchair. In the occurrence the sled is being towed in tandem as designed for multiple simultaneous rescues, a right-side sidewalk side door can be used for entry and egress.

The TRS does not operate as a life-saving rated vehicle and does not provide life-saving measures aside from limited evacuation from perilous consequences. The Basic Life Support provisions supplied to every TRS will be limited to a wall-fastened basic first aid kit. A wall-fastened, ANSI-rated class “ABC” fire extinguisher designed for construction materials. 8 solar reflective, high R-value winter rescue safety blankets attached to the seat. A basic single, folding litter-style cot attached to the wall by strap.

The TRS ceiling is constructed of 1″ tube steel, bow frame, 16″ on center. It is insulated by a 1″ R4 foam core board and covered by sound and barrier foam and bright white FRP board.

### 2. STELLA Exterior

The exterior of the sled is clad in bright safety orange for ease of visibility in weather-blind conditions and is marked as a specific rescue vehicle.

The TRS boasts multiple low-power/high LED lighted components throughout the unit. Exterior deck white LED bar lights, alternating yellow to white hazard lights, corner spot pod LED lights as well as amber lights designed to cut through falling snow are mounted along the rooftop and the sides for 360-degree lit visibility in all conditions.

FIG. 1 depicts a side elevation view of a chassis and platform 1 of the STELLA Transportable Rescue Sled (TRS), that combines a dynamic design with basic operation. After extensive strength testing of various metals and substrates, it was decided that the chassis and platform 1 be constructed of a 2″×3″×⅛ thick steel box beam, providing a stable platform under normal operation, while also capable of withstanding flexing and externally exerted force conditions.

Steering and direction are executed by utilizing an upper control arm 8, 27 depicted in FIG. 1, and a lower control arm 14, 23, also depicted in FIG. 1, operably coupled to a steering knuckle 10, 24 and wheel hub 11, 25. These, are connected via four (4) ball joint connections 3, 4, 9, 21 to the main steering control arms 18, 29. The steering control arms 18, 29 are operably coupled to the steering knuckle 10, 24, and the steering direction control plate 303, shown in FIG. 3 and FIG. 4A. By way of this operable coupling of the steering knuckle 10 as a coupling between the steering control arm 29 and the wheel hub 11 or ski attachment 31 for turning the sled 1 in the intended direction the independent components, now operably coupled, are effectively converted into a single curved assembly.

Thus, the connection at the frame remains rigid, locking the Strut Coilover Spring 6 20 in place with 3 bolts. Both upper and lower control arms are also mounted by ½ inch bolt to a rigid, pivot point attached to the frame (FIG. 1) and allows only up and down movement of the Strut Coilover Shock 6, 20. The Upper and Lower control arms also, only are capable of an up and down pivot.

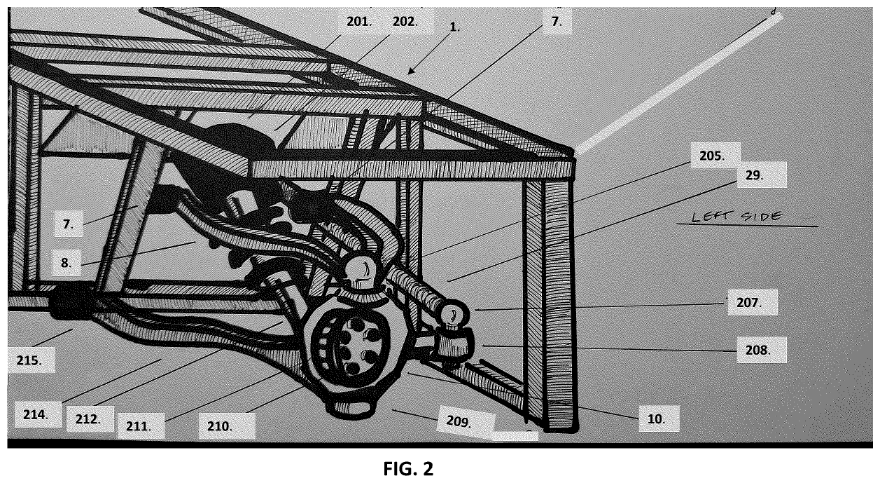

FIG. 2 depicts a side elevation view of a steering knuckle 10 as a coupling between the steering control arm 29 and the wheel hub 11 or ski attachment 31 for turning the sled 1 in the intended direction. This operable coupling of the steering knuckle 10 as a coupling between the steering control arm 29 and the wheel hub 11 or ski attachment 31 for turning the sled 1 in the intended direction effectively converts the independent components, now operably coupled, into a single curved assembly

FIG. 3 depicts a plan view of a direction control connection arm 304 to which external force may be applied via the actions of the pulling source into the intended direction of travel. Upon engagement, the steering control arms 18, 29, depicted in FIG. 1, pivot inward and outward activating the steering knuckle 10, 24, also depicted in FIG. 1, thus turning the wheel hub 11, 25 and also a wheel or ski attachment 30, 31 in the intended direction of travel.

The direction control connection arm 304 may be operably coupled to the steering direction control plate 303, depicted in FIG. 3, by inserting the direction control arm into a steering direction control plate 303, operably coupled, i.e., mechanically and physically attached to a standard two-inch style receiver guide 307, depicted in FIG. 3. This type of connection is Department of Motor Vehicles tested and accepted for highway use and remains widely utilized and common to everyday towable trailers. Once the receiver guide 307 is placed onto the two-inch standard ball hitch 17, shown in FIG. 1. The receiver guide 307 may be locked in position by engaging the two-inch receiver locking pin 308. The basic operation of this type of connection allows for a wide range of dynamic physical motion without disengaging. Further, the connection style is common creating ease of understanding and use as well as troubleshooting by the operator. A pre-deployment checklist will require a close inspection of the connection and a “pull test” before field operations.

Completion of connecting or operably coupling the direction control connection arm 304 to the pulling source using a pintle ring 306 design, is shown in FIGS. 3A and 3B. FIG. 3A depicts a plan view of the steering direction control plate 303. FIG. 3B depicts a cross-sectional view of FIG. 3A, as viewed in the direction of arrows along the line 3B-3B of FIG. 3A. This is common when traction vehicles commonly tasked with towing the Rescue Sled are used.

In one embodiment a steering assembly 500 for a towable rescue sled, comprising a bearing body 425, bearing base mounts 428, bearing studs 422, A Zerk grease fitting 431, A bearing swivel base 434, a steering pivot plate 400, a linking tow bar mounting pivot point 401, a gusset stopper 418, gusset plates 419, a linking toe bar 507 with a swing pin hole, a bolt or pin for the swing pin hole, gusset plate, on top and bottom, a right side front steering control arm 18, tie rod bolts 516, a right front Steering knuckle 24, a left side front steering control arm 29, and a left front Steering knuckle 10. wherein the bearing body is operably coupled to the bearing base mounts. Wherein the bearing studs operably couple the bearing body to the steering pivot plate via the barring mounting holes. Wherein the gusset stopper's gusset plates keeps the linking bar from pivoting more than 45 degrees up or down during travel. Wherein the steering pivot plate mounting ear 413 connected to the tie rod, the tie rod is connected to the radius arm, the radius arm is connected to a second tie rod. The second tie rod connects to the steering knuckle. The steering knuckle is mounted between an upper and lower control arm. The steering knuckle movement only allows for swiveling right to left. The upper and lower control arm only allow the suspension assembly to move up or down noy right or left. The steering knuckle is operably coupled to the wheel hub. The wheel hub is connected to the running gear. Depending on the direction of the pivot plate. The toe bar pulls straight, clockwise or counter clock wise. Clockwise arranges the wheel hubs and the running gear to the right, counter clock wise arranges the wheel hubs and the running gear to the left.

SUSPENSION DESCRIPTIONS AND FACTORS:

In considering the application of the suspension it was decided that:

Part number: #139105—Strut Coilover Shock 6, 20, was found to be the most practical and capable application.

The part is designed to carry 2,700 lbs. individually. There are four (4) total on the sled, with one each placed at either corner of the sled.

STELLA Rescue sled unladed—4,060 lbs.

STELLA Rescue Sled Maximum capacity and cargo—8 Passenger. Not to exceed 2000 lbs.

STELLA Rescue Sled fully loaded—6,000 lbs. Part no: 139105 2,700 lbs.×4=10,800 lbs. Recognizing a positive use surplus of 4,000 lbs. Aiding in the typical movement, torque forces and physical performance dynamics.

The body structure of the cabin compartment is connected and reinforced to a carbon steel, 3/16 thick, 3″ by 2″ chassis frame 1, (FIG. 1). The chassis frame 1 (FIG. 1) is connected to the top of the Strut Coilover Shock 6, 20. The Strut Coilover Shock 6, 20 is connected at the bottom to a heavy duty, standard lower control arm. 214. (FIG. 2.).

The connection at the frame remains rigid, locking the Strut Coilover Shock 6, 20 in place with 3 bolts 2, 5 (FIG. 1). Both upper 8, 27 and lower control arms 14, 23 are also mounted by ½ inch bolt 7 to a control arm, to a rigid, pivot point attached to the frame 1, (FIG. 1) and allows only up and down movement of the Strut Coilover Shock 6, 20. The Upper and Lower control arms also, only are capable of an up and down pivot.

### Steering Pivot Plate

The Steering Pivot Plate 400, main function is to maintain control and direction of the steering radius arms 510, 513. The dynamic engagement of the steering pivot plate 400 is instituted by introduced terrain and environmental forces.

The Steering Pivot Plate's 400 main connection and swivel control is via a high speed, 6 lug serviceable steel bearing 434 (FIG. 4C) mounted to the chassis or platform 1 of the STELLA. The bearing is rated and designed for 4 ton of capacity load and high speed input. It can be serviced by a grease fitting 431.

Steering Action explanation:

For explanation please refer to the graphic:

“STEERING PIVOT PLATE—45 DEGREE ACTION DESIGN”

1. The radius arm linkage 510, 513. will drive inward, or outward depending on applied force of the steering demands.

### Example

If the pulling source is executing a left turn, the linking tow bar 507, will engage and pivot the Steering Pivot Plate 400, resulting in a negative (pulling) input of force upon the plate and will create a corresponding negative (pulling) action upon the radius arm 510 and negative (pulling) action upon the radius arm 513. The opposite forces are true for the right turn scenario.

2. The Steering Pivot Plate 400 is inserted into to a 4″ by 4″ carbon steel channel 437, Linking Tow Bar 507 to the Steering Pivot Plate. The linking Tow Bar #6 is connected via a ⅝ Short Shank, Grade 8 nut and bolt #5. The Linking Tow Bar is rounded at the end and designed to swing upward, or downward depending on the applied forces of the towing unit and terrain.

### Example

If the pulling source is encountering an incline, or decline of no greater than a 45 degree angle, regardless of upward or downward, the Linking Tow Bar 507 will pivot to allow the STELLA freedom of movement and a flexible approach to the oncoming terrain.

3. When not engaged by steering input, the radius arms are designed for continually straight tracking.

### Example

The radius arms 18, 29 have a Tie rod 510, 513 connection at either end allowing for position and mechanical adjustment inward, and outward upon the Steering Pivot Plate 400. These tie rods 510, 513. are connected at one end to the Steering Pivot Plate 400 at the linking toe bar's ⅝ in. mounting hole 416, and the opposite end steering knuckle 10, 24. (FIG. 1) The connection is rigid, and not designed to be flexible while in forward tracking.

The complex design creates a sturdy and durable platform never before manufactured in this manner for this purpose. Basic functional operation creates a reliable, multi-person rescue resource placing capabilities, where no ability was before.

The STELLA Rescue Sled is the only answer.

### 3. Additional Features And Benefits

On-site mechanical operation or handheld applications via encrypted cellular devices allow these functions to be implemented in person by an operator or by nonadjacent incident command.

The location and condition are continually monitored via a satellite tracking application designed to ping and locate with hourly frequency, sharing this information with the op application concurrently. The limited power required for the GPS tracking unit is supplied by a standard 9 v battery. Removal, monitoring, and replacement will require technical acknowledgment and be included for review and documentation in the unit-specific annual condition and safety reports.

While exemplary embodiments have been specifically disclosed, it should be understood that the practice of this invention is not limited to those embodiments.

Modifications and variations falling within the spirit of the invention will occur to those skilled in the art. Therefore, it is not intended that the scope of the invention be determined by the disclosed exemplary embodiments, but rather should be determined by the breadth of the appended claims.

What is claimed is:

1. A towable rescue sled, comprising:
a load bearing chassis and platform 1, said load bearing chassis and platform 1 being supported by a suspension assembly and steered by a steering assembly,
wherein said suspension assembly and suspension assembly and a steering assembly utilize an upper control arm 8, 27 depicted in FIG. 1, and a lower control arm 14, 23, also depicted in FIG. 1, operably coupled to a steering knuckle 10, 24 and wheel hub 11, 25. These, are connected via four (4) ball joint connections 3, 4, 9, 21 to the main steering control arms 18, 29. The steering control arms 18, 29 are operably coupled to the steering knuckle 10, 24, and the steering direction control plate 303, shown in FIG. 3 and FIG. 4A. By way of this operable coupling of the steering knuckle 10 as a coupling between the steering control arm 29 and running gear for turning the sled 1 in the intended direction the independent components, now operably coupled, are effectively converted into a single curved assembly, and
wherein said steering assembly comprises:
a steering pivot plate 400, operably coupled to a bearing swivel base 434, comprising:
bearing studs, 422;
a bearing body, 425; and
bearing base mount(s) 428.

2. The apparatus of claim 1 where the running gear is selected from the group consisting of wheel hubs 11, ski or wheel attachment 31.

3. The apparatus of claim 1 where the towable rescue sled does not have an onboard motor and cannot move itself.

4. A steering assembly 500 for a towable rescue sled, comprising:
A bearing body (425),
bearing base mounts (428),
bearing studs (422),
A Zerk grease fitting (431),
A bearing swivel base (434),
A steering pivot plate (400),
A linking tow bar mounting pivot point (401),
A gusset stopper (418),
Gusset plates (419),
A linking toe bar (507) with a swing pin hole, a bolt or pin goes through gusset plate, on top and bottom,
A right-side front steering control arm (18),
tie rod bolts (516),
A right front Steering knuckle (24),
A left side front steering control arm (29),
A left front Steering knuckle (10)
wherein the bearing body is operably coupled to the bearing base mounts,
wherein the bearing studs operably couple the bearing body to the steering pivot plate via the barring mounting holes,
wherein the gusset stopper's gusset plates keep the linking bar from pivoting more than 45 degrees up or down during travel,
wherein the steering pivot plate mounting ear (413) is connected to tie rod, the tie rod is connected to the radius arm (18, 29), the radius arm being connected to respective tie rod (510,
wherein the second tie rod connects to the steering knuckle,
wherein the steering knuckle is mounted between an upper and lower control arm,
wherein the steering knuckle movement only allows for swiveling right to left,
wherein the upper and lower control arm only allow the suspension assembly to move up or down not right or left,
wherein the steering knuckle is operably coupled to the wheel hub,
wherein the wheel hub is connected to the running gear, depending on the direction of the pivot plate,
wherein the toe bar pulls straight, clockwise or counter clock wise,
wherein clockwise arranges the wheel hubs and the running gear to the right, and counter clock wise arranges the wheel hubs and the running gear to the left.
